(19) United States
(12) Patent Application Publication
(10) Pub. No.: US 2012/0125290 A1
(43) Pub. Date: May 24, 2012

(54) HYDROGENE ENGINE

(76) Inventor: Manfred Moder, Munich (DE)

(21) Appl. No.: 13/302,230

(22) Filed: Nov. 22, 2011

Related U.S. Application Data
(63) Continuation of application No. PCT/EP2010/056337, filed on May 10, 2010.
Application No. PCT/EP2010/056337 is a continuation of application No. PCT/EP2010/057040, filed on May 21, 2010.

(30) Foreign Application Priority Data
May 25, 2009 (DE) 10 2009 022 472.6
Oct. 13, 2009 (DE) 10 2009 045 627.9

(51) Int. Cl. F02B 5/00; C25B 9/00

(52) U.S. Cl. 123/445; 204/242

(57) ABSTRACT

An internal combustion engine for converting energy released during the combustion of a fuel, in particular an H₂-0₂ mixture, into mechanical work. The internal combustion engine includes at least one drive shaft connected to at least one chamber component that has at least one explosion chamber, at least one fuel supply for introducing fuel into the explosion chamber, and at least one ignition device for igniting fuel so introduced, The engine provides a relatively high torque at low engine speeds if the explosion chamber has at least one outlet through which ignited fuel is released to the surroundings, wherein the outlet is arranged such that the reaction generated by the escape of the ignited fuel exerts a torque on the at least one chamber component.

### PRIORITY CLAIM

This application is a continuation of pending International Application No. PCT/EP2010/057040 filed on May 21, 2010, which designates the United States and claims priority from German Patent Applications No. 10 2009 022 472.6 filed on May 25, 2009 and 10 2009 045 627.9 filed on Oct. 13, 2009, each of the above-mentioned applications is incorporated herein by reference in its entirety.

### BACKGROUND OF THE INVENTION

1. Field of the Invention

The invention relates to a hydrogen engine, or, more generally: an internal combustion engine for conversion of energy released by the combustion of fuel, in particular a mixture of Hydrogene (H₂) and Oxygene (0₂), into mechanical work. In addition, this invention relates to a hydrogen generator, especially for supplying an internal combustion engine with an H₂-0₂ mixture as fuel. The hydrogen generator has a generator chamber, in which at least two electrodes are arranged and fed with electric power, for splitting water in the generator chamber electrolytically into H₂ and O₂.

2. Description of Relevant Art

Hydrogen is regarded as one of the most promising future sources of energy. Hydrogen has about 2.6 times as much energy density as petrol (based on the mass). Hydrogen can be electrolytically generated with very high efficiency out of nearly limitlessly available water or, by the Kvaerner process, out of biomass. Energy stored in hydrogen can be converted by internal combustion engines into mechanical work or by a fuel cell into electric power.

French patent publication with the number FR 2 778 430 discloses a rotary engine. The rotary engine has a rotor with two explosion chambers. Each of the chambers has an outlet for ignited fuel. The ignited fuel escapes through the outlets and the recoil of the escaping fuel exerts a torque on the rotor.

German Patent Publication DE 2 927 973 discloses a Wankel like hydrogen engine.

U.S. Pat. No. 2,458,128 discloses a steam engine with a rotor. The rotor has plurality of curved steam exit slots or channels communicating with a steam receiving channel and ending in steam exit openings. Steam is expanded when leaving the steam openings. The recoil of the expanded steam exerts a torque on the rotor.

### SUMMARY OF THE INVENTION

The object of the invention is to provide an internal combustion engine for the conversion of chemical energy stored in hydrogen, into mechanical work. A further object is to provide an efficient hydrogen generator.

The internal combustion engine according to an embodiment of the invention is suitable in particular for the conversion of energy that is released by the combustion of an H₂-0₂ mixture into mechanical work. Of course, other fuels may also be burnt in the internal combustion engine—or, for short, the hydrogen engine, as it will be also called in the following. The internal combustion engine has at least one drive shaft which is connected to a chamber component so that it rotates with the chamber component. The chamber component includes at least one explosion chamber. The explosion chamber is at least partially filled with fuel by at least one fuel supply. Then, an ignition device ignites the fuel that was introduced into the explosion chamber. The explosion chamber has at least one outlet which releases ignited fuel into the environment. Escape of ignited fuel produces a recoil which exerts a torque on the chamber component and drives it thus. The outlet is preferably constructed like a nozzle. The chamber component transfers this torque to the drive shaft. After the fuel is burnt, the explosion chamber is at least partially refilled with fuel that may be ignited again.

The fuel supply includes preferably at least one channel recess in the drive shaft. The channel recess may in particular include a blind hole that is axially driven from one end into the drive shaft. The channel recess communicates preferably with a fuel channel of the chamber component. Fuel can be very easily introduced by the channel recess and, if necessary, by the fuel channel into the rotating explosion chamber of the chamber component, because the channel recess may be connected via a rotating joint to a fuel reservoir. Thus there is no need for mounting a—much more complex—rotating joint to the chamber component.

At least one check valve is preferred to be integrated near the channel recess and/or the rotating joint, to prevent the explosion from provoking a light-back into the fuel reservoir.

Before ignition, the fuel in the explosion chamber is preferably uncompressed, i.e. 0.85*p₀<p_{K}(<1.15*p₀, with p_{S} indicating fuel pressure outside the explosion chamber and p_{K} signifying fuel pressure inside the explosion chamber. The explosion chamber features therefore before ignition at least about the same pressure level which is prevalent outside the explosion chamber. Thus the combustion temperatures may remain rather low, and the cooling expenditure will also remain low.

The chamber component includes preferably at least one burst disk, which is situated coaxially on the drive shaft and has at least one recess, serving as an explosion chamber. An explosion chamber of this kind facilitates the introduction of fuel into the explosion chamber and its ignition there very much. The ignited fuel may escape e.g. by a lateral opening of the explosion chamber, so that its recoil generates a torque which is transferred to the drive shaft.

Parallel to the axis, the explosion chamber is ideally sealed by at least one capping, preferably on both sides. Such a capping facilitates easy assembly and, if necessary, an inspection of the explosion chamber or the whole burst disk.

In particular the capping(s) may include a fuel channel of the fuel supply and/or at least parts of the ignition device. This provides for a most robust and easy-to-service design of the chamber component.

The fuel channel to the explosion chamber preferably has at least one valve which is closed at least during the combustion of the fuel, e.g., a check valve. This prevents light-back of the combustion into parts of the fuel supply that are found outside the chamber component. Thus it is possible to introduce by the fuel channel an ignitable fuel mixture into the explosion chamber. Consequently it is sufficient to provide for one fuel channel, possibly branching, and/or one fuel outlet per explosion chamber.

The valve preferably includes a spring-loaded tappet which is shifted by at least one control cam to open and/or close the valve when the chamber component is rotating. The control cam is preferably installed at a housing of the internal combustion engine and is shaped like a ramp. The control cam may be driven out of a control disk which is connected to the housing. Preferably the position of the control cam is adjustable, so that the moment when the valve opens may be timed, i.e. the position of the valve relative to the housing towards which it is opened. The moment of opening can be timed most easily if the control cam is driven out of a control disk which may be turned relative to the housing. For example, the control disk may feature elongated holes, shaped like ring segments, through which at least one mounting bolt is driven, so that the control disk can be turned relative to the housing, if the mounting bolts are loosened, while, if the mounting bolts are tightened, the control disk will be fixed at the housing.

For ignition, the ignition device includes preferentially at least one electric spark generator that rotates with the chamber component and is fed by at least one rotary joint. This allows for timing ignition almost arbitrarily. Of course the rotary joint can transfer the power required for ignition by sliding contacts and/or inductively from the non-rotating environment to the chamber component rotating inside of it, and/or to the ignition device. Since the spark generator is rotating with the chamber component, the explosion chamber can be very easily sealed. Otherwise, two mutually rotating parts would have to be sealed against each other in such a way that there was no appreciable pressure loss, even when the fuel was exploding in the explosion chambers. In addition, the sealing would have to permanently withstand explosive combustion of the fuel in the explosion chamber.

The fuel supply includes preferentially at least one pipe and/or a section of a pipe, which near the chamber component is thermically insulated against the explosion chamber. This allows to transport an ignitable fuel mixture in this pipe or section without invoking spontaneous combustion of the fuel mixture inside the fuel supply, which would damage the fuel supply. Thermally insulated is supposed to mean here that there is e.g. an insulating layer between the explosion chamber and the fuel supply. The same effect can be achieved by active cooling of at least one part of the fuel supply. In particular the fuel supply can be coaxially enveloped with a cooling pipe. Of course, cooling and insulation may be also combined.

Not only ignitable fuel may be filled into the explosion chambers, but preferably also a liquid which evaporates at least in parts, when exposed to the heat generated by fuel combustion, and also escapes by the outlet. Evaporation of the liquid profoundly increases the volume, so that the liquid, now turned gaseous, is pressed through the outlet, intensifying the recoil and thus the torque on the drive shaft.

Also, the evaporating liquid reduces the heat that is generated by the explosion, and therefore, efficiency is increased. The liquid may be water, in particular, which is preferably injected into the explosion chamber so that it obscures the chamber at least partially. Most preferably, the liquid is first introduced into the explosion chamber, e.g., as a fog, and only after that, fuel is filled into the explosion chamber. This facilitates cooling of the explosion chamber before introducing fuel so much that spontaneous fuel combustion at hot residuals of the preceding combustion or at the hot chamber walls is prevented. Then, during the next combustion of the fuel, the liquid evaporates with all the above-mentioned advantages.

The internal combustion engine accordingly includes preferably at least one coolant pipe with at least one outlet in the explosion chamber, introducing a liquid into the explosion chamber. At least a part of this liquid will evaporate during the combustion of the fuel. Efficiency can thus be increased, as described above.

The outlet of the coolant pipe which is leading into the explosion chamber is preferentially designed as an atomisation nozzle. The surface of the liquid in the explosion chamber is thus increased, and the liquid will evaporate quickly and evenly.

Besides, the coolant pipe contains preferably at least one coolant valve, e.g., a coolant check valve, so that any pressure developing in the coolant pipe from combustion will not vent off by the outlet but by the coolant pipe. In addition, the coolant valve allows to control timing and amount of liquid entering the explosion chamber.

In particular the coolant pipe can be designed in such a way that a column of liquid will remain between the outlet leading into the explosion chamber and the coolant valve after the introduction of liquid is finished. This column of liquid is positioned in front of the valve, seen from the perspective of the explosion chamber, and will protect the coolant valve and any components behind the valve from high thermal load by heat produced by the exploding fuel.

The coolant pipe is preferably installed inside the chamber component. For example, the coolant pipe may feature a U-shaped segment in the chamber component, with the lower part of the U-segment pointing radially outwards. This way, a column of liquid will remain in the U-segment when the chamber component rotates, shielding any components in that leg of the coolant pipe which is turned away from the coolant pipe's outlet—as for example a coolant check valve or any components connected to it, such as a coolant pump—against high thermal load by the heat of the exploding fuel. The explosion heats up that part of the liquid which is kept in that section of the coolant pipe which is leading towards the coolant pipe*s outlet. Then at least a part of this preheated liquid is introduced into the explosion chamber. Since it is already warmed up, less power is required to evaporate it. Efficiency can thus be further increased, while the chamber component is cooled by the inflowing liquid.

Electrolytic production of hydrogen out of water was till now achieved by using metallic electrodes which are very expensive. Most astonishingly, tests have shown that carbon electrodes, which are substantially cheaper, also enable highly efficient electrolytic splitting of water. The hydrogen generator, which is in particular suitable for supplying the above described internal combustion engine with a H2-02 mixture, accordingly features a generator chamber, in which at least two carbon electrodes are arranged and connected to a power supply to be fed with electric power.

When operating the hydrogen generator, the active surface of the carbon electrodes decreases in the course of time. Using in addition to the carbon electrodes at least one auxiliary metal electrode on each side, e.g., made of stainless steel, provokes a layer of coal to accumulate on the metal electrodes, so that the active surface of the electrodes will be preserved. To clean the auxiliary metal electrodes, it is enough to switch off the carbon electrodes briefly and to reverse the polarity of the auxiliary metal electrodes, e.g., only for the fraction of a second. The amassed coal dust will then fall to the ground, and the auxiliary electrodes may again accumulate fresh carbon. The voltage applied to the auxiliary metal electrodes when reversing polarity should preferably be lower than the minimum voltage required for the electrolysis of water. This facilitates the separate collection of highly purified gases (H₂ and O₂).

Preferably, at least one of the metal auxiliary electrodes should surround one of the carbon electrodes. E.g., a cylindrical carbon electrode may be coaxially placed inside a tubular auxiliary metal electrode.

The hydrogen generator includes preferably at least one emergency outlet, which is closed by at least one pressure relief valve. If the production of gases generates a pressure which is higher than the opening pressure of the pressure relief valve, then the pressure will be drained through the emergency outlet. In particular, water can be drained through the emergency outlet, for then there is no increased risk of fire or explosion, other than with the blowing off of one or both gases. At the latest when the water was completely drained, electrolysis is interrupted, i.e. no more gas is produced and thus no more pressure develops in the hydrogen generator.

The hydrogen generator preferably includes at least one fan, to rapidly and thoroughly dilute any gas which was released to the environment by the emergency outlet in housing of overpressure, so that the risk of fire or explosion is reduced. The fan may be driven in particular by a brushless electric motor. Such a motor generates no sparks which could cause a fire or an explosion.

The hydrogen generator preferably includes at least one pressure switch to interrupt the electrolytic splitting of water into H₂ and O₂ if the pressure in the hydrogen generator should rise above a predetermined value. In particular the pressure switch may separate electrodes from the power supply, e.g., all cathodes and/or all anodes.

### BRIEF DESCRIPTION OF THE DRAWINGS

In the following, the invention will be described by way of example, without limitation of the general inventive concept, on examples of embodiment and with reference to the drawings.

FIG. 1: an internal combustion engine

FIG. 2: an drive shaft

FIG. 3: a side view of a housing

FIG. 4: a front view of the housing

FIG. 5: a burst disk

FIG. 6: a front view of the internal combustion engine (partially disassembled)

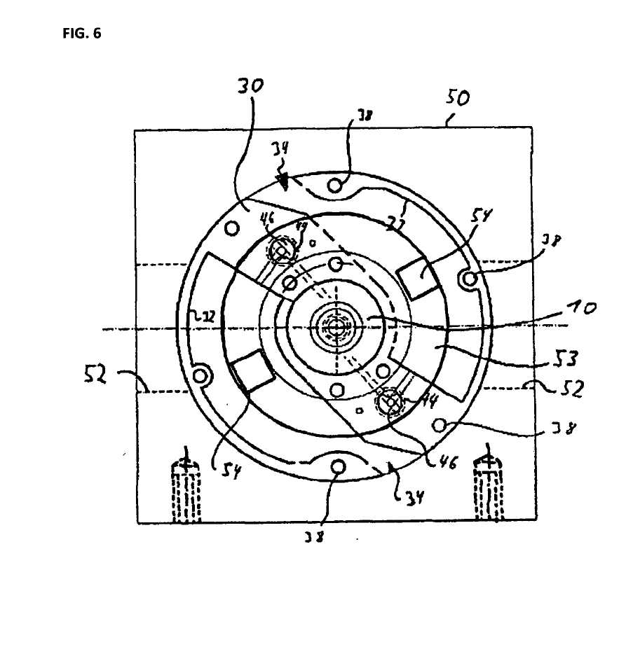

FIG. 7: a lateral cover

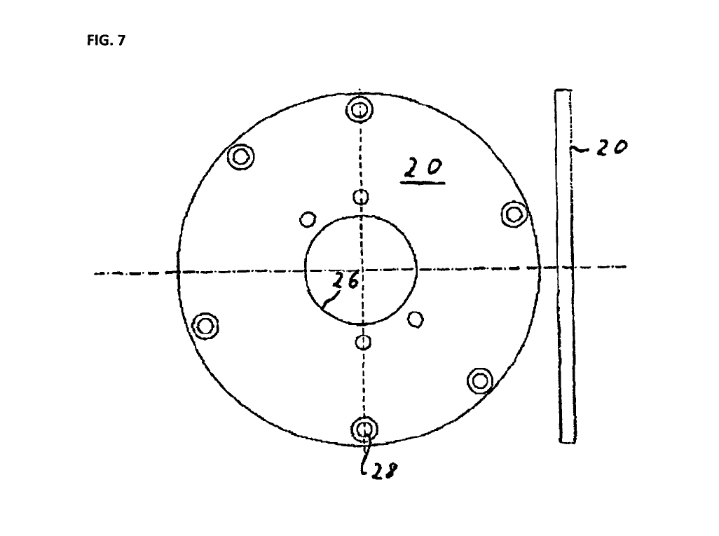

FIG. 8: a slip ring disk

FIG. 9: a front view of the internal combustion engine with slip ring disk, and

FIG. 10: a detail of FIG. 9 in section,

FIG. 11: a hydrogen generator.

### DETAILED DESCRIPTION OF THE PREFERRED EMBODIMENTS

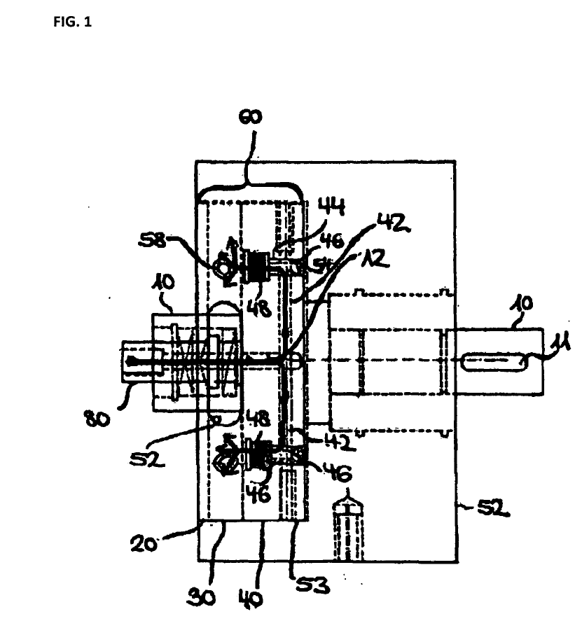

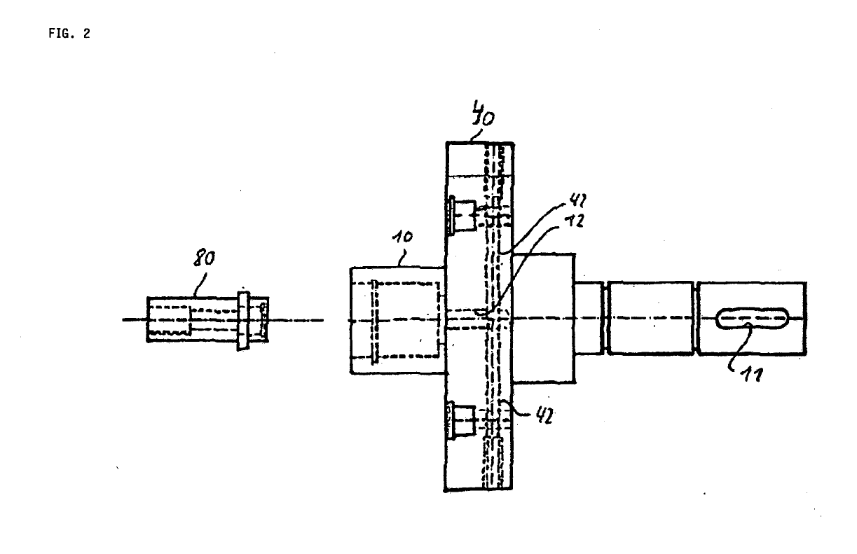

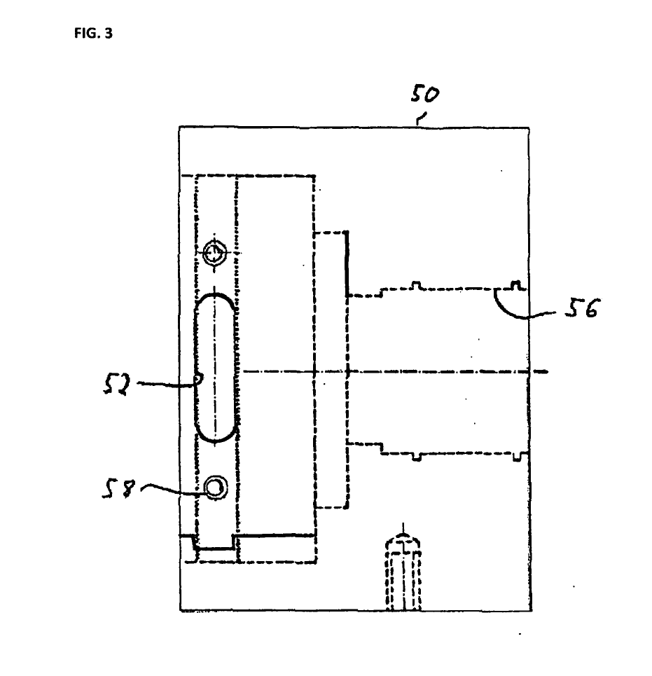

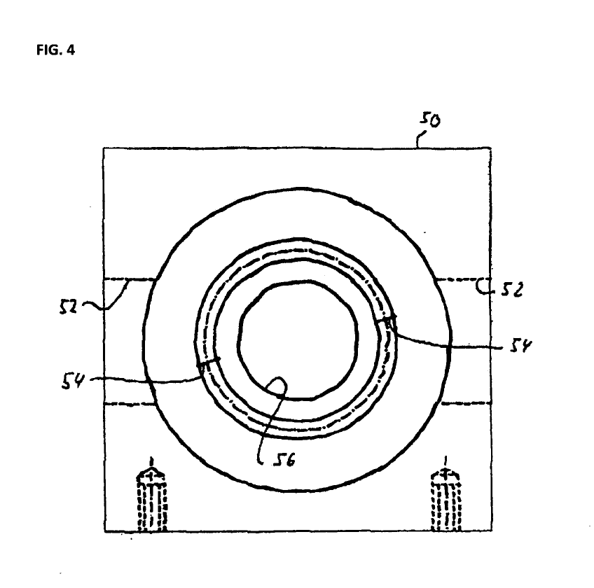

FIG. 1 is depicting an internal combustion engine. The internal combustion engine has a housing 50. A side and a front view of the housing 50 are depicted in FIG. 3 and FIG. 4 respectively. The housing 50 supports a drive shaft 10. The drive shaft is depicted in FIG. 2. The drive shaft protrudes on both sides from the housing 50 and may rotate in the housing 50 (cf. FIG. 1). On one side of the housing 50, the drive shaft features a keyway 11, to connect e.g. a pulley, a clutch plate, a gearwheel or a similar element to rotate with the drive shaft 10. Inside of the housing 50, a chamber component 60 is fixed to the shaft 10 and rotating with it. The chamber component 60 includes a first cover 20 and a second cover 40. A burst disk 30 is arranged between both of them. The drive shaft 10 has a channel recess 12 (cf. FIG. 1) which is shaped like a coaxial blind hole and serving as a part of a fuel supply. The channel recess 12 communicates with a fuel channel 42 in the second lateral cover 40. The fuel channel 42 has two branches which are leading radially outward, each issuing into a valve housing 44. In the valve housing is a valve tappet 46 which is charged with a valve spring 48. The valve housing 44, the valve tappet 46 and the valve spring 48 combine into a check valve (cf. FIG. 1).

An injector 80 is located in the channel recess 12 of the drive shaft, conducting an ignitable fuel mixture through the channel recess 12 and the fuel channel 42 to the two valves and from there on into each one of two explosion chambers 32 of the burst disk 30. The injector 80 is mounted swivelling in the shaft, i.e. it does not rotate with the shaft but serves as a connection for a fuel pipe. The injector possesses a check valve (not shown) which safely prevents any light-back of an explosion into the fuel pipe. The fuel duct from the injector 80 to the recesses 32 is in FIG. 1 indicated by a line with directional arrows.

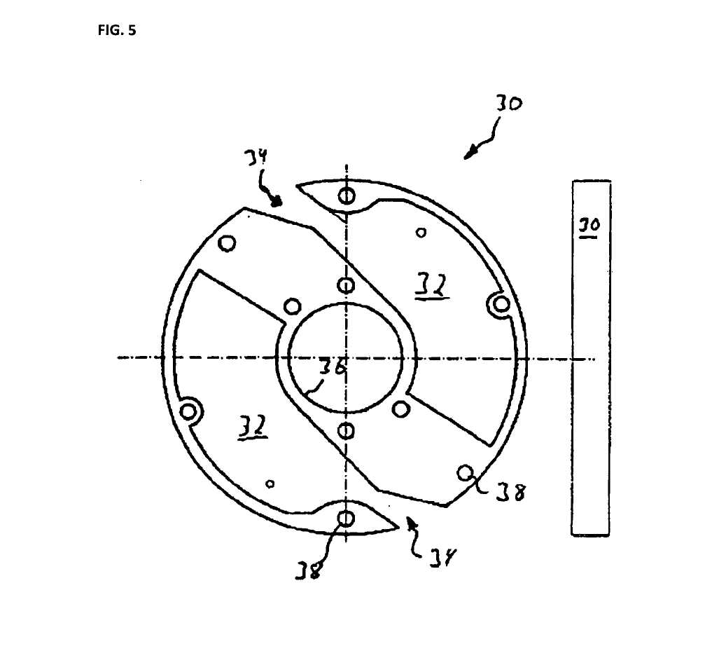

FIG. 5 depicts the burst disk 30 in the front view (left) and the side view (right). The burst disk has two recesses 32, being the explosion chambers. These, when mounted, are laterally closed by the first and second lateral covers 20 and 40 (cf. FIG. 1). The explosion chambers 32 each have a nozzle-shaped outlet 34 (cf. FIG. 5). The symmetric axes (not shown) of the nozzle-shaped outlets 34 of the explosion chambers 32 are secants of the radius of the burst disk 30 (as far as FIG. 5 is concerned; three-dimensionally, they are in fact symmetry planes intersecting the enveloping cylindrical surface of the chamber component 60). If an ignitable fuel, e.g., a H₂-O₂ mixture, is ignited in the explosion chambers 32, then the developing heat causes the ignited fuel to expand in all directions, so that at least a part of the ignited fuel escapes by the outlets 34 from the explosion chamber 32. This causes a recoil which exercises a torque on the burst disk 30, driving the drive shaft 10 which is mounted co-rotating with the burst disk 30.

The valves have to be opened to fill the explosion chamber 32. For this purpose there is a control disk 53 in a recess of the housing, featuring two control cams 54 which are shaped like ramps. While the chamber component is rotating with the shaft 10 inside the housing, the tappets 46 are shifted by the control cams 54 against the force of the valve springs 48. This opens the valves, and fuel may flow into the explosion chambers 32. The valves close shortly before the outlets 34 of the explosion chamber 32 start to communicate with the environment via housing outlets 52. After that, i.e. when the outlets 34 are communicating via the housing outlets 52 with the environment, the fuel in the explosion chambers 32 is ignited by an ignition device 22 (only to some extent shown) which is integrated into one in the first lateral cappings, and an explosion is triggered.

At least a part of the combustion product is now squeezed out of the explosion chambers via the outlets 34 of the explosion chambers 32 and the housing outlets 52. Each explosion chamber 32 is filled and ignited twice during each full rotation of the drive shaft 10. In the illustrated example, the internal combustion engine has therefore two power strokes per rotation. Of course the number of the housing outlets and valves can be changed, so that the internal combustion engine may feature only one or more than two power strokes per rotation.

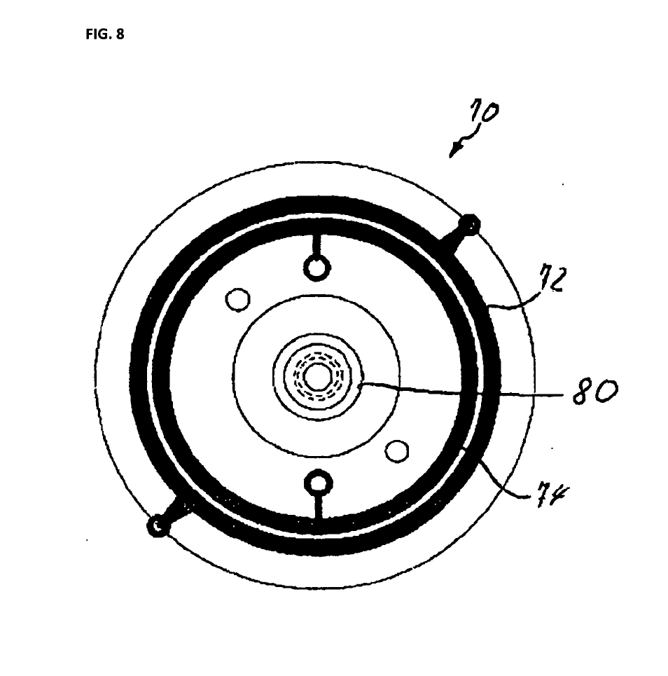

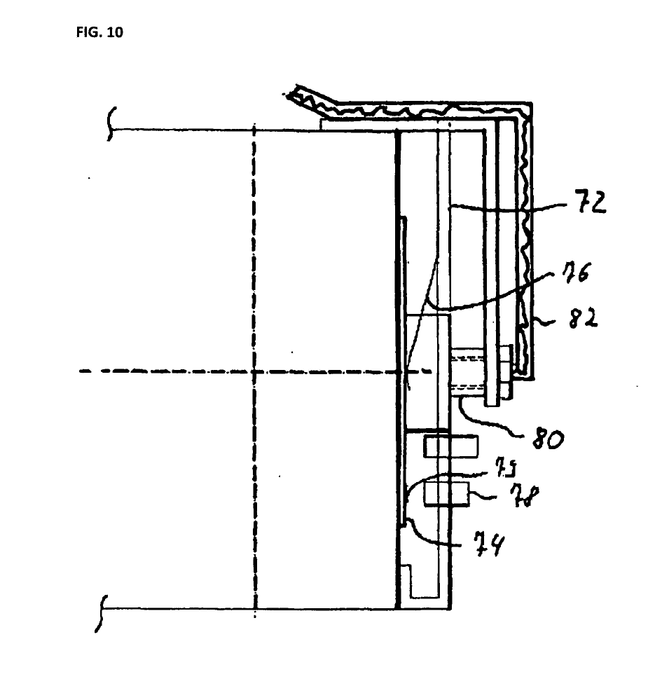

In front of the first lateral capping 20 there is a slip ring disk 70 (cf. FIG. 8 to FIG. 10). The slip ring disk 70 includes an outer rim 72, which is connected rigidly with the housing, and an inner rim 74, which is connected rigidly with the first lateral cover 20. A sliding contact 76 is provided (cf. FIG. 10) to electrically connect the outer and the inner rim of the slip ring. The inner rim 74 is connected to the ignition devices 22. The ignition devices 22 are controlled by a transistor igniter (not shown) which uses at least one measuring sensor 78 to register the position of the chamber component 60 relative to the housing 50. Using this information, the igniter controls the spark timing.

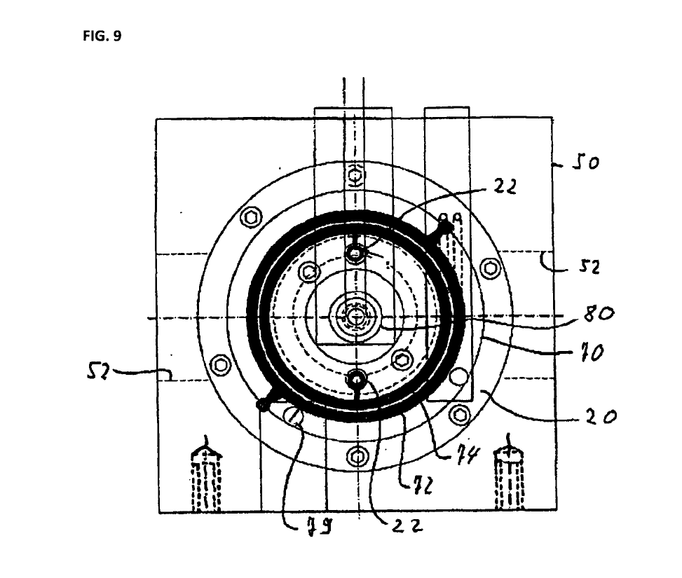

FIG. 9 and FIG. 10 indicate how the injector 80 is connected by a conduit 82 with a fuel source, e.g., a fuel tank or a hydrogen generator, feeding the internal combustion engine with fuel. The illustrated internal combustion engine is designed for operation with a H₂-O₂ mixture (in a ratio of 2 mol of H₂ VS. 1 mol of O₂). For safety reasons it is useful if hydrogen and oxygen are conducted by separate pipes to the injector and mixed only as closely as possible to the explosion chamber or even inside of it. In the illustrated example the mixing takes place inside the injector.

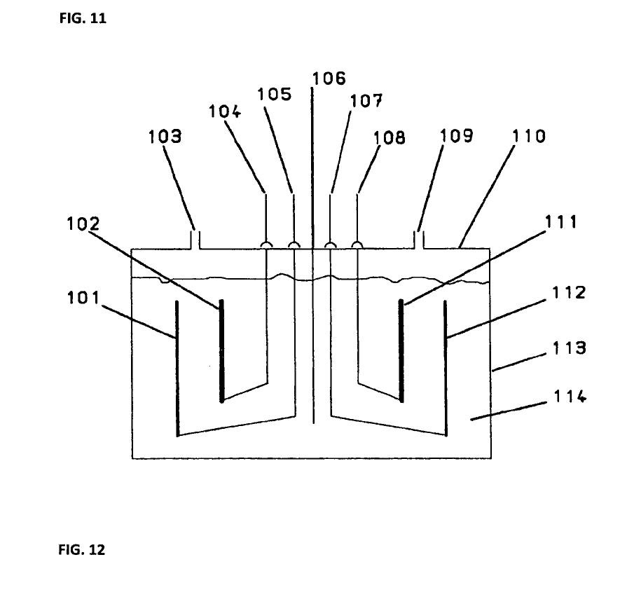

FIG. 11 shows a hydrogen generator with a generator housing 113. Water was filled by an intake 114, which is not shown, into the generator housing 113. The generator housing 113 is closed by a generator housing cover 110 which may be removed for purposes of inspection. In the generator housing 113 there are two stainless steel electrodes 101, 112 and two coal electrodes 102, 111. Each of the stainless steel electrodes 101, 112 is paired with one of the coal electrodes 102, 111, to create an electrode couple. The generator housing 113 is divided by a partition 106 into two parts, so that on both sides of the partition 106 there is one electrode couple, combined out of either of the stainless steel electrodes 101, 112 and either of the coal electrodes 102, 111. The partition hangs down from the generator housing cover 110 between the two electrode couples to at least the level of the lower ends of the electrode couples, so that both parts of the generator housing 113 may communicate below the partition with each other.

To generate H₂ and O₂, the stainless steel electrode 101 and the coal electrode 102, combined into one electrode couple, are attached by connections 104, 105 in parallel to a pole of a power source (not shown), and the stainless steel electrode 112 and the coal electrode 111, combined into the other electrode couple, are connected to the other pole of the power source. The voltage between both electrode couples is set on a value which is at least equal to that voltage which is needed to split water electrolytically. Accordingly, the water is split electrolytically into H₂ and O₂. The gases rise to the generator housing cover 110, and the two gases H₂ and O₂, separated by the partition 106, accumulate below the generator housing cover 110. There they are separately drained by outlets 103 and 109.

During electrolysis, a layer of coal accumulates on the stainless steel electrodes 101, 112. For removing the coal layer from the stainless steel electrodes 101, 112, the coal electrodes will be separated from the power supply, and the polarity of the two stainless steel electrodes is reversed. When reversing the polarity of the stainless steel electrodes 101, 112, the applied voltage should preferably be lower than the minimum voltage required to split water electrolytically, so that no O₂ and no H₂ are produced while the polarity of the stainless steel electrodes 101, 112 is reversed. This way, mixing of the gases is avoided. By reversing the polarity of the voltage applied between stainless steel electrodes 101, 112, the coal layer comes loose of the stainless steel electrodes 101, 112 and drops to the floor of the generator housing 113. There it can be sucked off. After at least of the coal layer has dropped down, the polarity of the voltage at the stainless steel electrodes 101, 112 is reversed back, and the coal electrodes 102, 111 are reconnected to the power supply. Now the voltage applied to the electrodes is set again on a level which is sufficient for the electrolytic splitting of water into O₂ and H₂, so that the production of gas is continued.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

It will be appreciated to those skilled in the art having the benefit of this disclosure that this invention is believed to provide a hydrogen engine and a hydrogen generator. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

10 Drive shaft
11 Keyway
12 Channel recess
13 Key
20 Lateral capping (first one)
22 Ignition device
30 Burst disk
32 Explosion chamber
34 Outlet of the explosion chamber 32, here shaped like a nozzle
36 Central recess for drive shaft 10
38 Holes for bolts to brace the burst disk 30 between the cappings 20.40
40 Lateral capping (second one)
42 Fuel channel
44 Valve housing
46 Tappet
48 Valve spring
50 housing
52 Case outlet for combustion products
53 Control disk
54 Control cam
56 Case recess for drive shaft, support, etc.
58 Fastening for silencer
60 Chamber component
70 Slip ring disk
72 Outer slip ring rim
74 Inner slip ring rim
76 Sliding contact
78 Measuring sensors
79 Ignition timer
80 Injector
90 Pulley
101 Stainless steel electrode (e.g., anode)
102 Coal electrode (e.g., anode)
103 Outlet
104 Connection coal electrode
105 Connection stainless steel electrode
106 Partition
107 Connection stainless steel electrode
108 Connection coal electrode
109 Oxygen outlet
110 Generator housing cover
111 Coal electrode (e.g., cathode)
112 Stainless steel electrode (e.g., cathode)
113 Generator case
114 Water

1. An internal combustion engine for converting energy, released by combustion of fuel, into mechanical work, the internal combustion engine comprising:
at least one drive shaft being connected to at least one chamber component, the at least one chamber component having at least one explosion chamber with at least one outlet configured as a passage for ignited fuel, wherein the at least one outlet is further configured such that a recoil created by the ignited fuel passing through the at least one outlet produces a torque on the at least one chamber component,
at least one fuel supply configured to provide fuel to the at least one explosion chamber, and
at least one ignition device configured to ignite said fuel provided to the at least one explosion chamber,
wherein the at least one chamber component includes at least one burst disk, mounted coaxially on the at least one drive shaft, the at least one burst disk having at least one recess adapted as an explosion chamber, the explosion chamber being closed in axial direction on both sides by at least one capping.

2. The internal combustion engine according to claim 1, wherein the at least one fuel supply includes at least one channel-like recess in the at least one drive shaft.

3. The internal combustion engine of claim 1, wherein the at least one fuel supply includes at least one fuel channel in the at least one chamber component.

4. The internal combustion engine of claim 1, wherein the at least one capping includes at least one of a fuel channel of the fuel supply and at least part of the ignition device.

5. The internal combustion engine of claim 1, wherein the at least one fuel channel provides at least one valve which is closed at least during combustion of the fuel such as to prevent light-back of the combustion into a part of the at least one fuel supply which is outside the at least one chamber component.

6. The internal combustion engine of claim 5, wherein the at least one valve includes a spring-loaded tappet which is adapted to shift during rotation of the at least one chamber component such as to change an operational state of a valve with the use of a control disk.

7. The internal combustion engine of claim 1, wherein the at least one ignition device includes at least one spark generator configured to rotate with the at least one chamber component and be in electrical communication with at least one sliding contact.

8. The internal combustion engine of claim 1, wherein the at least one fuel supply is disposed at least in the vicinity of the at least one chamber component thermally isolated from the at least one explosion chamber.

9. The internal combustion engine of claim 1, wherein the at least one fuel supply is configured to be coolable at least in the vicinity of the chamber component.

10. A hydrogen generator including a generator chamber in which at least three electrodes are arranged, the at least three electrodes being in electrical communication with at least one power source configured to electrolytically split water in the generator chamber into H₂ and O₂, wherein at least one of the three electrodes includes carbon and wherein at least one metal electrode from the at least three electrodes is connected in parallel to the at least one electrode including carbon with the at least one power source.
